(19) United States
(12) Patent Application Publication
(10) Pub. No.: US 2026/0264392 A1
(43) Pub. Date: Sep. 10, 2026

(54) PRINTING APPARATUS, CONTROL METHOD, AND STORAGE MEDIUM

(71) Applicant: CANON KABUSHIKI KAISHA, Tokyo (JP)

(72) Inventors: KYOSUKE DEGUCHI, Kanagawa (JP); YUHEI OIKAWA, Kanagawa (JP); KOHEI SATO, Kanagawa (JP); KAZUKI TAKAHASHI, Tokyo (JP); ATSUHIKO MASUYAMA, Kanagawa (JP); TAKAFUMI ITO, Kanagawa (JP); SACHIKO YAMAUCHI, Kanagawa (JP)

(21) Appl. No.: 19/532,150

(22) Filed: Feb. 6, 2026

(30) Foreign Application Priority Data
Mar. 5, 2025 (JP) 2025-034512

(51) Int. Cl. B41J 2/045; B41J 2/14; B41J 25/00

(52) U.S. Cl. CPC B41J 2/04508; B41J 2/04556; B41J 2/04563; B41J 2/0457; B41J 2/0458; B41J 2/1408; B41J 25/001; B41J 2202/08

(57) ABSTRACT

A printing apparatus includes a conveying unit, a print head, a printing element substrate, a temperature adjusting unit, a changing unit configured to change the relative position between the print head and the conveying unit, and a control unit. The control unit drives the temperature adjusting unit to adjust the temperature of the printing element substrate while the print head performs printing, and drives the changing unit to relatively space the print head and the printing medium after printing is completed, and then reduces the power of the temperature adjusting unit.

### BACKGROUND

### Field of the Technology

The present disclosure relates to a printing apparatus, a control method, and a storage medium.

### Description of the Related Art

In the field of printing apparatuses that perform printing by ejecting liquid onto storage media, it is generally known that after printing is completed, warm and wet atmosphere (air) is present between a print head and a printing medium. When this atmosphere is cooled, condensation may occur, which causes liquid droplets to adhere to an ejection orifice surface of a print head. The occurrence of condensation may affect the liquid ejection performance of the print head, resulting in degradation in printing quality.

Japanese Patent Laid-Open No. 2005-22160 discloses a liquid ejection head equipped with a heater (sub-heater) for heating the lower surface (ejection orifice surface) of the liquid ejection head (print head). In the liquid ejection head disclosed in Japanese Patent Laid-Open No. 2005-22160, the ejection orifice surface is heated by the heater, which makes it possible to restrain the temperature of the ejection orifice surface from dropping below the dew point of the atmosphere under the ejection orifice surface.

### SUMMARY

The present disclosure is directed to provide a printing apparatus capable of restraining occurrence of condensation.

A printing apparatus includes a conveying unit for conveying a printing medium in a conveying direction, a print head configured to perform printing by ejecting liquid onto the printing medium, a printing element substrate provided on the print head and having an ejection orifice surface on which ejection orifice for ejecting liquid is formed, a temperature adjusting unit configured to adjust temperature of the printing element substrate, a changing unit configured to change a relative position of the print head and the conveying unit, and a control unit configured to control driving of the conveying unit, the print head, the printing element substrate, the temperature adjusting unit, and the changing unit, wherein the control unit drives the temperature adjusting unit to adjust the temperature of the printing element substrate while the print head is performing printing, drives the changing unit to relatively space the print head and the printing medium apart from each other after printing is completed, and then reduces power of the temperature adjusting unit.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram showing an example of a printing apparatus according to an embodiment;

FIG. 2 is a block diagram showing an example of a control system according to the embodiment;

FIG. 3 is a block diagram showing an example of a printing control unit according to the embodiment;

FIG. 4 is a schematic bottom view of a print head according to the embodiment;

FIG. 5A is a diagram showing an example of a printing element substrate according to the embodiment;

FIG. 5B is an enlarged view of an area shown in FIG. 5A;

FIG. 5C is a diagram showing an example of a cover plate according to the embodiment;

FIG. 6 is a perspective view showing a section taken along a line VI-VI shown in FIG. 5A;

FIG. 7A is a diagram showing an example of an ejection orifice surface of the printing element substrate according to the embodiment;

FIG. 7B is a schematic diagram showing an internal structure of the printing element substrate;

FIG. 8A is a schematic diagram showing a print pattern when focusing on a particular printing element substrate;

FIG. 8B is a diagram showing an adverse effect caused by condensation;

FIG. 9 is a schematic diagram showing a countermeasure for condensation according to the embodiment;

FIG. 10 is a flowchart in the embodiment; and

FIG. 11 is a flowchart in an embodiment.

### DESCRIPTION OF THE EMBODIMENTS

Preferable embodiments of the present invention will be described in detail below with reference to the accompanying drawings. Note that the embodiments described below are not intended to unnecessarily limit the technical concepts of the present disclosure. Furthermore, all of the features described in the following embodiments are not necessarily essential means for solving the problems of the present disclosure.

### First Embodiment

### <Printing Apparatus 100>

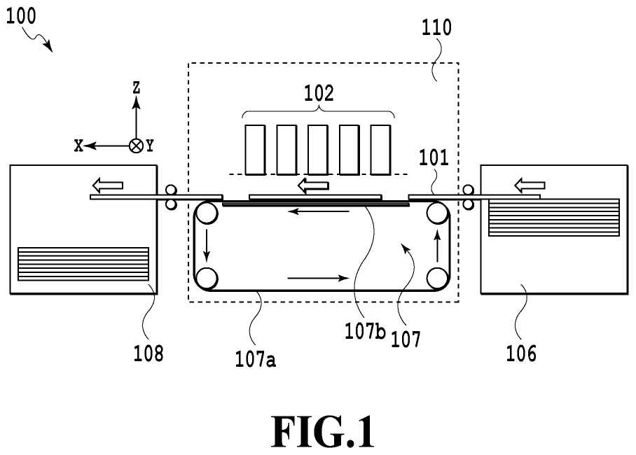

FIG. 1 is a schematic diagram showing an example of a printing apparatus 100 that can be applied to the present embodiment.

Coordinate axes shown in the drawings of the present disclosure will now be described. An X-direction corresponds to the width direction (longitudinal direction) of the printing apparatus 100. A Y-direction corresponds to the depth direction of the printing apparatus 100. A Z-direction corresponds to the height direction (direction of gravity) of the printing apparatus 100. In the present embodiment, a printing medium 101 is conveyed in the X-direction. Therefore, the X-direction also corresponds to the conveying direction of the printing medium 101. The Y-direction also corresponds to the width direction of the printing medium 101.

In the present disclosure, “printing” does not only mean forming meaningful information (for example, characters, figures, etc. that are visualized such that they can be visually perceived by humans). “Printing” also means that meaningless information is formed. Furthermore, in the present disclosure, “printing” broadly means forming an image, a design, a pattern, a structure, or a combination thereof on a printing medium, or processing a medium.

“Printing medium” includes not only sheet to be used in general printing apparatuses, but also ink-receivable media such as cloth, plastic film, metal plate, glass, ceramics, resin, wood, and leather.

As shown in FIG. 1, the printing apparatus 100 is configured to be capable of performing printing on a printing medium 101 by ejecting liquid (e.g., ink). In the present embodiment, the printing apparatus 100 is an inkjet printing apparatus, and the description will be made on the assumption that the printing medium 101 is cut sheet.

The printing apparatus 100 includes a feeding unit 106 for feeding the printing medium 101, a printing unit 110 for performing printing on the printing medium 101, and a discharge unit 108 for discharging the printing medium 101. The printing unit 110 includes a conveying unit 107 for conveying the printing medium 101, and a print head 102 for ejecting liquid onto the printing medium 101. The conveying unit 107 includes a conveyor belt 107a for conveying the printing medium 101 while keeping the printing medium 101 in a smoothly fixed state.

When the printing medium 101 is fed from the feeding unit 106 to the printing unit 110, the printing medium 101 is conveyed to a position under the print head 102 by the conveying unit 107. When the printing medium 101 is conveyed to a position under the print head 102, liquid is ejected from numerous ejection orifices (not shown) formed in the print head 102, thereby printing an image on the printing medium 101. When printing on the printing medium 101 is completed, the printing medium 101 is discharged from the printing unit 110 to the discharge unit 108 by the conveying unit 107.

Although not provided in this embodiment, units (not shown) having functions such as drying, fixing, cooling, and sheet reversing may be provided between the printing unit 110 and the discharge unit 108 to be arranged at any positions appropriate for the system.

### <Print Head 102>

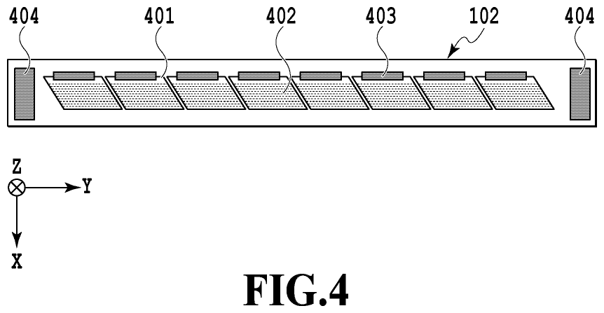

In the present embodiment, a full-line head extending in the width direction (Y-direction) of the printing medium 101 is used as the print head 102. A plurality of printing element substrates 401 (see FIG. 4, etc.) are provided at a bottom section of the print head 102. A plurality of ejection orifices 402 (see FIG. 4, etc.) are formed along the width direction (Y-direction) of the print head 102 on the ejection orifice surfaces (the surfaces facing downward in FIG. 1) of these printing element substrates 401. These ejection orifices 402 are formed so as to be capable of covering the width (length in the Y-direction) of a largest image printing area that can be used for the printing medium 101.

When printing is performed on the printing medium 101, the ejection orifice surface of the printing element substrate 401, which is a surface where a plurality of ejection orifices are formed, is fixed to be spaced slightly (approximately 1 millimeter) apart from the surface of the printing medium 101 being conveyed by the conveyor belt 107a.

In the present embodiment, when printing is performed on the printing medium 101, a position where the ejection orifice surface is fixed to be spaced slightly apart from the upper surface of the conveyor belt 107a (the surface on which the printing medium 101 is conveyed while smoothly fixed) is called a “printing position.” In other words, the “printing position” can be rephrased as the position of the ejection orifice surface when liquid is ejected from the ejection orifice surface.

The distance (e.g., approximately 1 millimeter) from the ejection orifice surface of the print head 102 to a printing surface of the printing medium 101 to which the liquid is ejected in a state where the print head 102 is located at the printing position is shorter than a first distance (e.g., several centimeters) described later.

In the present embodiment, five print heads 102 that eject treatment liquid, cyan ink, magenta ink, yellow ink, and black ink respectively are provided along the conveying direction (X-direction). Note that the type and color of liquid, the order in which the above-mentioned five print heads 102 are arranged, and the number of print heads 102 are not limited to those described above.

The liquid to be ejected from the print head 102 is stored in a tank (not shown). The liquid is supplied from the tank to the print head 102 via a tube or the like.

### <Control System 200>

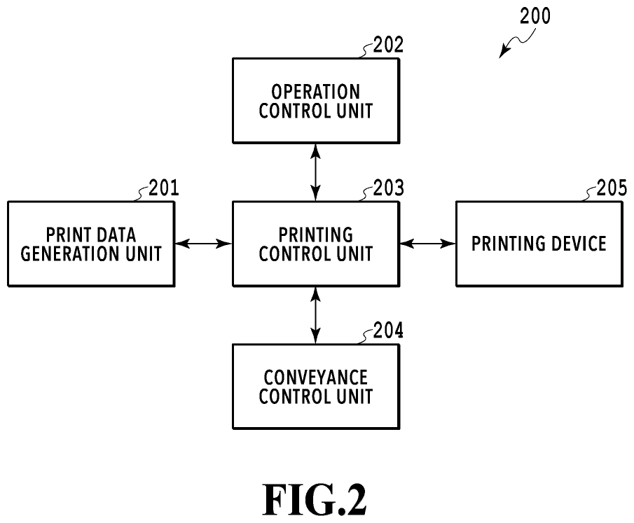

FIG. 2 is a block diagram showing an example of a control system 200 that is applicable to the present embodiment.

As shown in FIG. 2, the control system 200 for controlling the printing apparatus 100 includes, as components thereof, a printing data generation unit 201, an operation control unit 202, a printing control unit 203, a conveyance control unit 204, and a printing device 205.

The printing data generation unit 201 is a module for generating printing data, and sends the generated printing data to the printing control unit 203. Note that the printing data generation unit 201 may be provided inside the printing apparatus 100, or may be incorporated in a print server or the like that is provided externally to the printing apparatus 100.

The operation control unit 202 is a module that is to be operated by a user or service technician and receives instructions from the user or service technician. Specifically, the operation control unit 202 includes an operation panel provided on the printing apparatus 100 and an operation PC connected to the printing apparatus 100. Note that the present embodiment will be described on the assumption that the operation control unit 202 is an operation panel.

The printing control unit 203 is a module for executing a printing process. The conveyance control unit 204 is a module for conveying the printing medium 101 (see FIG. 1, etc.). The printing device 205 is a module to be used to control the operation of the print head 102 (see FIG. 1, etc.).

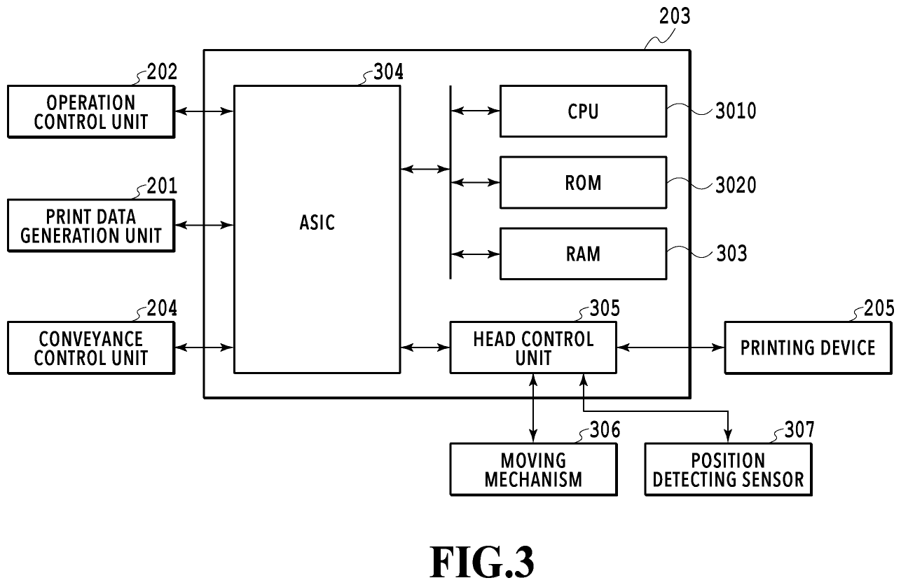

FIG. 3 is a block diagram showing an example of the printing control unit 203 that can be applied to the present embodiment.

As shown in FIG. 3, the printing control unit 203 includes CPU 3010, ROM 3020, RAM 303, ASIC 304, and the head control unit 305.

The CPU 3010 collectively controls the overall operation of the printing apparatus 100. A control program for the CPU 3010 and the like are stored in the ROM 3020. Data are temporarily stored in the RAM 303. The RAM 303 is used as a work memory when programs are executed. The ASIC 304 is an integrated circuit for a specific application that is incorporated with a network controller, a serial IF controller, a head data generation controller, a motor controller and the like. The head control unit 305 generates ejection data to be used by the printing device 205 and generates voltages to drive the printing elements 15 and sub-heaters 302.

A moving mechanism 306 controls the movement of at least one of the print head 102 and the conveying unit 107 to control the relative position between the print head 102 and the conveying unit 107. In the present embodiment, the print head 102 (see FIG. 1, etc.) is configured to be lifted up from a printing position (described below), thereby moving away from the conveying unit 107 (see FIG. 1, etc.). A position detecting sensor 307 detects the height position of the print head 102.

FIG. 4 is a schematic bottom view of the print head 102 that can be applied to the present embodiment. In other words, FIG. 4 is a view of the bottom face of the print head 102 which is viewed along the Z-direction from below the print head 102.

As shown in FIG. 4, a plurality of printing element substrates 401 are provided on the bottom face of the print head 102 so as to be arranged along the width direction (Y-direction). A plurality of ejection orifices 402 for ejecting liquid are formed along the width direction (Y-direction) on the ejection orifice surface of each of the plurality of printing element substrates 401. A single ejection orifice array is formed by forming a plurality of ejection orifices 402 along the width direction (Y-direction). A plurality of ejection orifice arrays are provided along the X-direction on the ejection orifice surface of the printing element substrate 401. The plurality of ejection orifice arrays are provided on the ejection orifice surface of the printing element substrate 401 such that the positions thereof in the X-direction are different from one another.

Specifically, 16 ejection orifice arrays are provided in the X-direction, each ejection orifice array having 512 ejection orifices 402 arranged at 600 dpi (dots per inch) in the Y-direction. Two ejection orifice arrays adjacent to each other in the X-direction are provided to be displaced from each other by 1200 dpi in the −Y direction.

First positioning members 404 for determining the position of the print head 102 in the Z-direction are provided at both end portions in the width direction (Y-direction) of the bottom face of the print head 102. Each of these positioning members 404 is configured to be capable of abutting against a second positioning member (not shown) provided on the conveying unit 107 (see FIG. 1, etc.) which faces the print head 102.

When printing is performed, the first positioning members 404 come into contact with the second positioning members, whereby the ejection orifice surfaces of the printing element substrates 401 are positioned with respect to the upper surface of the conveyor belt 107a (see FIG. 1), which makes it possible to maintain a constant distance during printing.

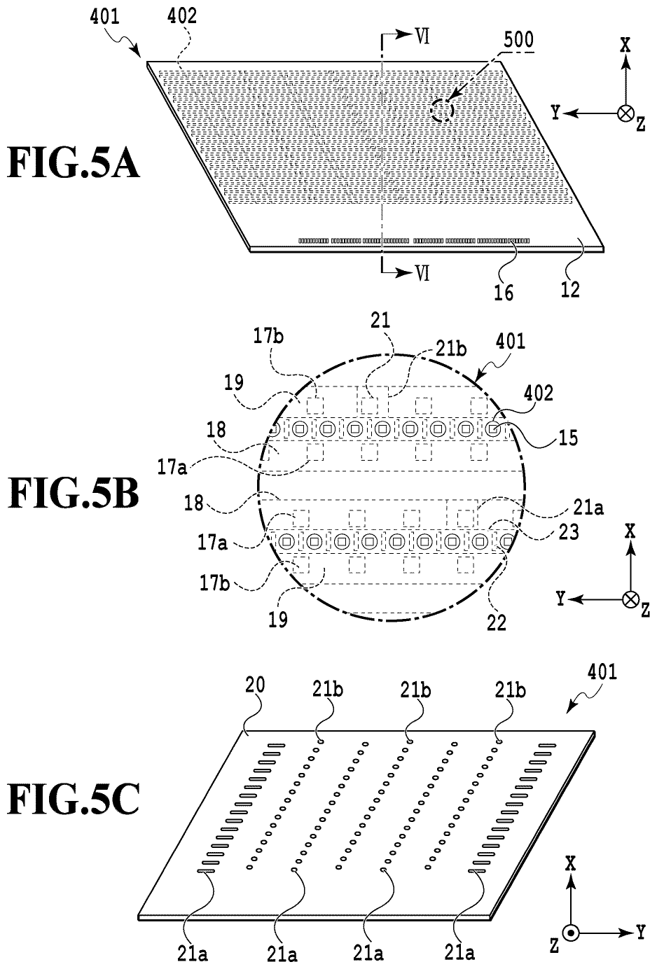

Furthermore, a sealant 403 is provided on the bottom face of the print head 102 to seal and protect terminals 16 (see FIG. 5A, etc.) provided on the printing element substrate 401.

### <Printing Element Substrate 401>

FIG. 5A is a diagram showing an example of the printing element substrate 401 that can be applied to the present embodiment.

As shown in FIG. 5A, the printing element substrate 401 includes an ejection orifice forming member 12 in which the ejection orifices 402 are formed. A plurality of terminals 16 are provided along the Y-direction at an end portion in the X-direction of the ejection orifice forming member 12. A flexible wiring board (not shown) having flexibility is connected to the terminals 16. A pulse signal and electric power for ejecting liquid are supplied to the printing element substrate 401 from the printing control unit 203 (see FIG. 2, etc.) via this flexible wiring board. A plurality of ejection orifices 402 are formed in the ejection orifice forming member 12 along the Y-direction.

FIG. 5B is an enlarged view of a region 500 in FIG. 5A.

As shown in FIG. 5B, a printing element 15 for generating bubbles in the liquid using thermal energy is provided at a position corresponding to each ejection orifice 402. In other words, in the present embodiment, an ejection heater is provided as the printing element 15.

A pressure chamber 23 in which the printing element 15 is provided is compartmented by partitions 22. The printing elements 15 and the terminals 16 are connected to each other by electrical wirings (not shown) provided on the printing element substrate 401. The printing elements 15 generate heat based on pulse signals input from the printing control unit 203 (see FIG. 2, etc.) via the above electrical wirings, which causes film boiling in the liquid. The force of bubbles generated by this film boiling causes the liquid to be ejected from the ejection orifices 402.

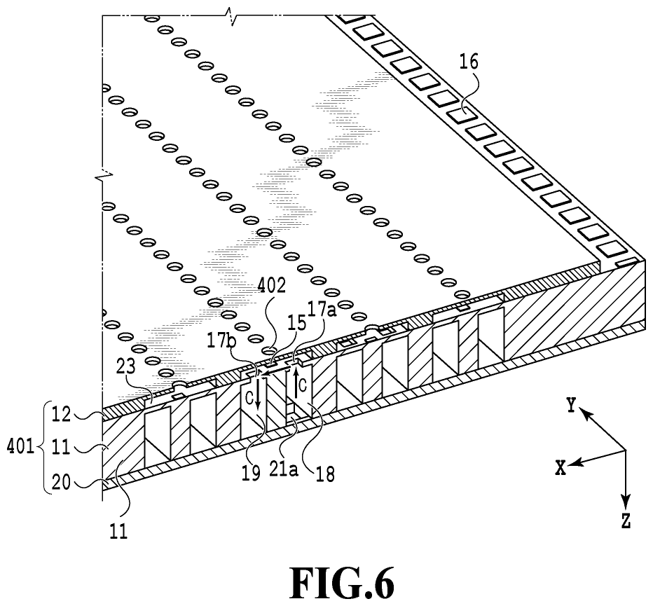

The printing element substrate 401 is provided with liquid supply paths 18 for supplying liquid to the ejection orifices 402 and liquid collecting paths 19 for collecting liquid which have not been ejected from the ejection orifices 402, each liquid supply path 18 and each liquid collecting path 19 being formed along each ejection orifice array. The liquid supply path 18 is adjacent to one side of each ejection orifice array in the X-direction, and the liquid collecting path 19 is adjacent to the other side of each ejection orifice array in the X-direction. The liquid supply paths 18 and the liquid collecting paths 19 are flow paths extending along the extending direction of the ejection orifice arrays. The liquid supply path 18 is connected to the ejection orifices 402 via supply ports 17a. Meanwhile, the liquid collecting path 19 is connected to the ejection orifices 402 via collecting ports 17b (see FIG. 6).

FIG. 5C is a diagram showing an example of a cover plate 20 that can be applied to the present embodiment.

As shown in FIG. 5C, a sheet-like cover plate 20 is attached to the back surface of the printing element substrate 401 (see FIG. 5A, etc.) which is opposite to the surface to which the ejection orifice forming member 12 (see FIG. 5A, etc.) is attached. Supply openings 21a connected to the liquid supply paths 18 (see FIG. 5B, etc.) and collecting openings 21b connected to the liquid collecting paths 19 (see FIG. 5B, etc.) are formed in the cover plate 20.

In the present embodiment, four supply openings 21a are formed for each liquid supply path 18, and three collecting openings 21b are formed for each liquid collecting path 19. However, the numbers of the supply openings 21a and the collecting openings 21b are not limited to this example.

FIG. 6 is a perspective view showing a section taken along line VI-VI in FIG. 5A.

As shown in FIG. 6, the printing element substrate 401 is constructed by laminating the cover plate 20, a substrate 11 made of silicon (Si) or the like, and the ejection orifice forming member 12 made of photosensitive resin in this order. The liquid supply paths 18 and the liquid collecting paths 19 are formed in the substrate 11. Pressure chambers 23 for receiving pressure when liquid is ejected are formed in the ejection orifice forming member 12.

Here, the flow of liquid inside the printing element substrate 401 will be described. The cover plate 20 functions as a lid that forms parts of the walls of the liquid supply paths 18 and the liquid collecting paths 19 in a state where the cover plate 20, the substrate 11, and the ejection orifice forming member 12 are stacked in this order. Printing elements 15 are provided on the substrate 11 at positions facing the ejection orifices 402 of the ejection orifice forming member 12. A plurality of grooves are formed on the back surface opposite to the surface on which the printing elements 15 are provided. These grooves function as the liquid supply paths 18 and the liquid collecting paths 19, respectively.

In this way, the liquid supply paths 18 and the liquid collecting paths 19 are formed by the substrate 11 and the cover plate 20. The liquid supply paths 18 are connected to a common supply channel (not shown), and the liquid collecting paths 19 are connected to a common collecting channel (not shown). A pressure difference occurs between each liquid supply path 18 and each liquid collecting paths 19. This pressure difference causes the liquid to flow through the supply opening 21a, the liquid supply path 18, the supply port 17a, the pressure chamber 23, the collecting port 17b, and the liquid collecting path 19 in this order as shown by arrows C in FIG. 6.

For example, with respect to ejection orifices 402 and pressure chambers 23 in which no ejection operation is being performed, this flow of the liquid described above allows makes it possible to collect, from the pressure chambers 23 to the liquid collecting paths 19, thickened ink occurring due to evaporation of water contained in ink from the ejection orifices 402, and bubbles and foreign matter in the ink. Furthermore, this flow of the liquid also makes it possible to restrain increase in viscosity of the ink and increase in concentration of colorant in the ejection orifices 402 and pressure chambers 23.

The liquid flowing through each of a plurality of liquid collecting paths 19 is joined in the common collecting channel (not shown) and collected in a buffer tank (not shown). The liquid pumped from the buffer tank (not shown) is passed through the common supply channel (not shown) and then resupplied to the liquid supply paths 18. In the present embodiment, a liquid circulation system is formed in this manner. A heat exchanger (not shown) is provided in the middle of the common supply channel. This heat exchanger controls the temperature of the liquid supplied to the liquid supply path to maintain 25° C.

### <Temperature Adjustment of Printing Element Substrate 401>

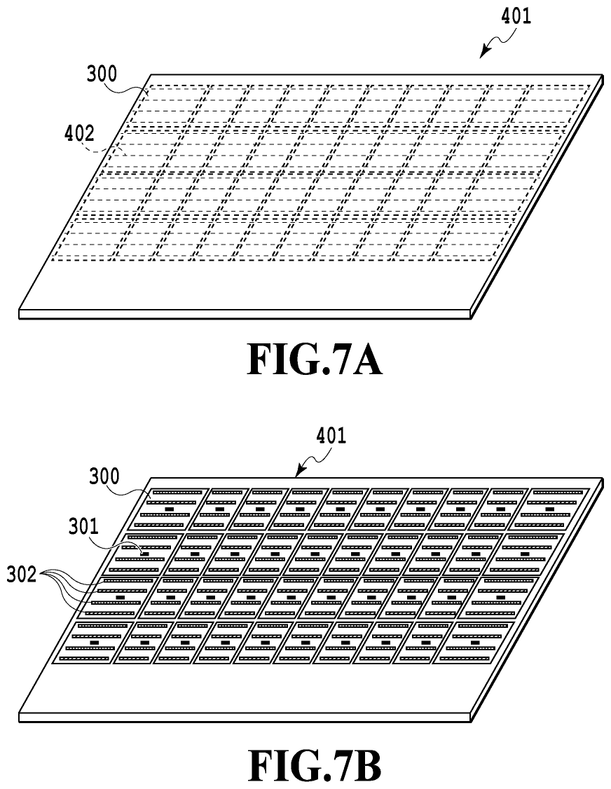

FIG. 7A is a diagram showing an example of the ejection orifice surface of the printing element substrate 401 that can be used in this embodiment.

As shown in FIG. 7A, in the present embodiment, the printing element substrate 401 is divided into 40 areas 300. The temperature of each of these areas 300 on the printing element substrate 401 is managed individually.

In FIG. 7A, the areas 300 are indicated by dashed lines for ease of understanding, but in reality, these dashed lines are not visible to the naked eyes.

FIG. 7B is a schematic diagram showing the internal structure of the printing element substrate 401. In FIG. 7B, the areas 300 are indicated by solid lines for ease of understanding, but in reality, these solid lines are not visible to the naked eyes.

As shown in FIG. 7B, one temperature sensor 301 and a plurality of sub-heaters 302 are provided for each area 300 inside the printing element substrate 401. In the present embodiment, four sub-heaters 302 are provided for each area 300. However, the number of sub-heaters 302 is not limited to four. Examples of the temperature sensor 301 include a diode sensor and an aluminum sensor.

In the present embodiment, a heating element different from the printing element 15 (see FIG. 6, etc.) is used as the sub-heater 302. Each of the plurality of sub-heaters 302 is individually controlled by the printing control unit 203 (see FIG. 2, etc.).

The printing control unit 203 adjusts the temperature of each area 300 by using the temperature sensor 301 and the sub-heaters 302 to heat the sub-heater 302 such that the temperature reaches a target temperature set for each area 300. In other words, the printing control unit 203 drives the sub-heaters 302 only when the temperature detected by the temperature sensor 301 is equal to or lower than the target temperature, thereby adjusting the temperature of each area 300. Accurate temperature adjustment is possible by adjusting the drive energy of the sub-heaters 302 according to the difference between the output value of the temperature sensor 301 and the target temperature value.

The main purpose of temperature control is to keep the amount of liquid ejected from each ejection orifice 402 constant. For example, when the liquid is ink, the amount of ink ejected from each ejection orifice 402 is determined by the size of bubbles which are generated by heating the printing elements 15. The size of the bubbles changes depending on the viscosity of the ink, and the viscosity of the ink changes depending on the temperature of the printing element substrate 401. Therefore, when the temperature of the printing element substrate 401 cannot be kept constant across the entire area, it is also difficult to keep the ejection amount of liquid constant.

For example, the ejection amount of liquid increases by approximately 1% as the temperature of the printing element substrate 401 increases by 1° C. Therefore, variation in temperature on the printing element substrate 401 causes variation in the ejection amount of liquid. When the ejection amount of liquid varies between areas, it causes variation in density on the printing medium 101 (see FIG. 1). In other words, variation in temperature on the printing element substrate 401 is a factor that degrades the quality of printing.

Therefore, in the present embodiment, temperature control is performed by the printing control unit 203 so that the temperature of the printing element substrate 401 is kept constant between areas. Furthermore, another purpose of temperature control is to suitably perform liquid ejection and liquid circulation. In order to suitably perform liquid ejection and liquid circulation, it is necessary to determine a minimum target temperature for the printing element substrate 401 and keep the temperature of each area of the printing element substrate 401 such that the temperature of the printing element substrate 401 is equal to or higher than that minimum temperature. In the present embodiment, the minimum target temperature of the target temperature is set to 38.0° C.

As described above, in the present embodiment, by performing the temperature control, the variation in temperature between areas on each printing element substrate 401 and variation in temperature among a plurality of printing element substrates 401 are controlled to converge within predetermined ranges. This makes it possible to reduce variation in ejection amount caused by temperature variation and restrain variation in density in a printed image.

### <Description of Problem Caused by Temperature Change of Printing Element Substrate 401>

A problem to be solved by the technique of the present disclosure will be described hereunder. In the printing apparatus 100 (see FIG. 1), when high-duty images are printed continuously, the quality of the images may gradually deteriorate.

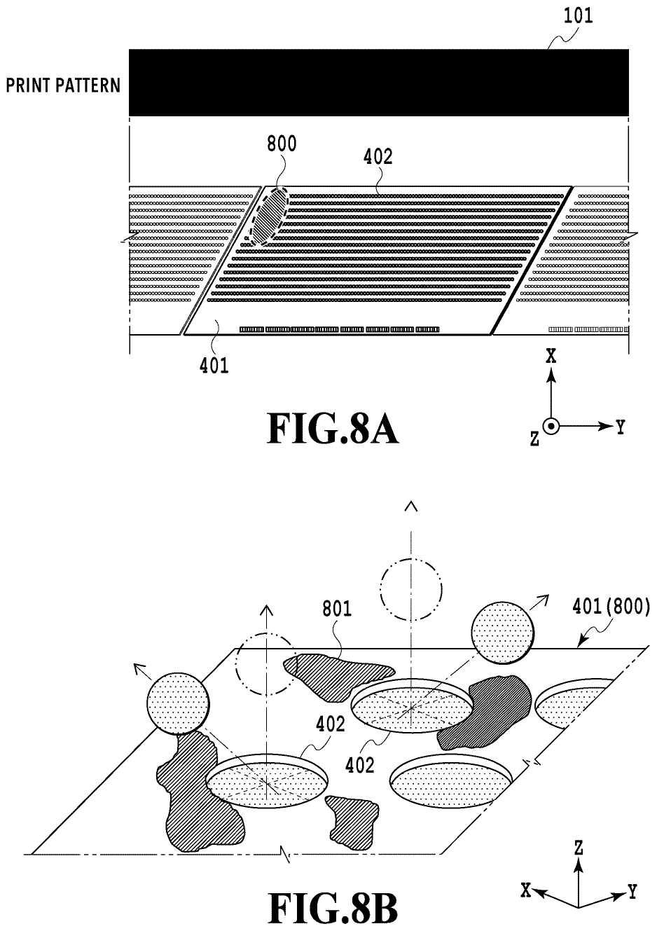

FIG. 8A is a schematic diagram showing a print pattern when focusing on a certain printing element substrate 401. FIG. 8A shows a situation in which this print pattern continues consecutively for approximately three hours. Note that the consecutive printing period is not limited to three hours.

FIG. 8A also shows a situation in which a 100% duty image is assigned to the entire area of the printing element substrate 401. In the present embodiment, 100% duty means a situation in which ink is applied to a printing medium 101 at a density of 7 g/m².

When high-duty printing is performed, the amount of an ink droplet to be ejected from the ejection orifice 402 is relatively large. As the amount of the ink droplet to be ejected from the ejection orifice 402 increases, the amount of ink landing on the surface of the printing medium 101 also increases. Therefore, due to the influence of moisture evaporating from the ejection orifices 402 and the printing medium 101, the relative humidity in the approximately 1 mm space between the ejection orifice surface and the printing medium 101 can reach approximately 100%.

Furthermore, in this case, the drive frequency of the printing elements 15 (see FIG. 6, etc.) is relatively high. For example, the temperature of the printing element substrate 401 reaches approximately 42° C. Therefore, the amount of saturated water vapor in the space between the ejection orifice surface and the printing medium 101 increases, so that the amount of moisture in this space further increases.

The printing medium 101 is conveyed in the conveying direction (+X-direction). Therefore, a conveying airflow flowing in the +X-direction is generated between the ejection orifice surface and the printing medium 101. In the present embodiment, the conveying speed of the printing medium 101 is set to 0.7 [m/sec].

The airflow generated in the space between the ejection orifice surface and the printing medium 101 follows according to Couette flow. The Couette flow means a phenomenon in which a fluid having viscosity flows as a laminar flow between two flat plates provided in parallel to each other. Couette flow occurs in a case where a lower flat plate (printing medium) moves at a constant speed while an upper flat plate (ejection orifice surface) remains stationary. The velocity distribution of the Couette flow changes linearly in proportion to the speed of the lower flat plate. The velocity of the Couette flow decreases as the upper flat plate is closer to the lower flat plate. This velocity distribution can be obtained by solving the Navier-Stokes equation. Specifically, when the upper flat plate moves at a speed U, the velocity “u(y)” of fluid is expressed like the following formula (1)

$$u ( y ) = y \times U / h \qquad ( Formula 1 )$$

Here, “y” indicates the position in the vertical direction between the two flat plates, and “h” is the distance between the two flat plates. This linear velocity distribution occurs due to action of internal frictional force caused by the viscosity of the fluid. According to the Couette flow, the velocity of the airflow flowing in the +X-direction on the printing surface of the printing medium 101 located approximately 1 mm away from the ejection orifice surface is approximately 0.7 [m/sec] which is roughly the same as the conveying speed.

On the other hand, as the position from the printing surface of the printing medium 101 approaches to the ejection orifice surface, the flow velocity gradually decreases, and it is considered that the velocity of the airflow in the neighborhood of the ejection orifice surface is theoretically equal to 0 [m/sec]. In other words, during printing, atmosphere having a humidity of approximately 100% remains between the ejection orifice surface and the printing surface without being moved by the conveying airflow.

During a process in which this high-temperature water vapor containing a large amount of moisture is moving relatively slowly downstream along the ejection orifice surface in the conveying direction according to the Couette flow, when the high-temperature water vapor comes into contact with a material whose temperature is lower than the temperature of the atmosphere, the atmosphere is cooled, and its saturated vapor pressure drops. As a result, the moisture that cannot be retained in the atmosphere any longer forms water droplets as dew condenses on the material with which the water vapor comes into contact.

In other words, it is considered that dew condenses occur on the ejection orifice surface on the condition that the temperature of the front surface of the ejection orifice surface on the downstream side in the conveying direction during high-duty printing is lower than the dew-point temperature of the air moving from upstream side in the conveying direction.

Assuming that the relative humidity of an atmosphere moving from the upstream side in the conveying direction is 100%, the dew-point temperature is equal to the temperature of the atmosphere itself. Therefore, when there is a temperature distribution on the ejection port surface, condensation occurs selectively in relatively cooler areas. Furthermore, in such a situation, when the power of the sub-heater 302 is reduced or the sub-heater 302 is turned off immediately after printing is completed, the printing element substrate 401 cools rapidly, and condensation may occur over a wide area of the ejection orifice surface.

For example, in the configuration of the present embodiment, when high-duty printing is performed continuously without taking any countermeasure to condensation, condensation may occur in an area 800 of the ejection orifice surface as shown in FIG. 8A.

FIG. 8B is a diagram showing an adverse effect of condensation. Note that description will be made with reference to FIG. 8B on the assumption that condensation has occurred in the area 800 in FIG. 8A.

As shown in FIG. 8B, when ink droplets are ejected, it is originally desirable to eject ink droplets linearly along the Z-axis. However, when condensation occurs, water droplets gradually combine on the ejection orifice surface of the printing element substrate 401, which forms wet areas 801 over a relatively broad region.

In particular, when a wet area 801 is formed near an ejection orifice 402, there is concern that the formation of the wet area 801 may affect the trajectory of ejected ink droplets. When ejecting ink droplets, it is originally desirable to eject the ink droplets linearly along the Z-axis. However, when a wet area 801 is formed near an ejection orifice 402, the ejected ink droplets may be attracted to water droplets in the wet area 801, which causes the trajectory of the ejected ink droplets to deviate from their intended trajectories (Z-axis). As a result, the accuracy of the ink-droplet application position on the printing medium 101 (see FIG. 1, etc.) deteriorates, which causes uneven density, degradation of line quality, degradation of character quality, etc.

One approach for restraining degradation of printing quality as described above is considered to interrupt printing before occurrence of condensation and clean the ejection orifice surface using a wiper (not shown) when high-duty printing is performed continuously. However, frequent cleaning can lead to reduced printing productivity and occurrence of downtime. In other words, when cleaning is frequently performed, it causes deterioration in user convenience. Therefore, it is desirable that the printing apparatus 100 is equipped with a mechanism for restraining condensation in addition to a wiper.

### <Configuration for Restraining Condensation>

As described above, when the temperature in the vicinity of the ejection orifice surface falls below the dew point, condensation may occur on the ejection orifice surface.

The following description assumes that the humidity in the space under the ejection orifice surface during continuous printing is approximately 100%. However, in practice, the manner of humidity diffusion changes depending on factors such as the distance between the ejection orifice surface and the printing medium and an airflow around the print head 102 (see FIG. 1). Therefore, even when the temperature on the downstream side of the print head 102 is lower than the temperature on the upstream side of the print head 102, condensation may not occur. This is because the humidity in the space under the ejection orifice surface is lower than 100%, and thus the dew point decreases.

When this condensation occurrence mechanism is considered, it is possible to restrain occurrence of condensation by heating the sub-heaters 302 (see FIG. 7B, etc.) to increase the temperature of the ejection orifice surface. However, when the power consumed to heat the sub-heaters 302 is considered, it is desirable to supply power to the sub-heaters 302 for a short period of time.

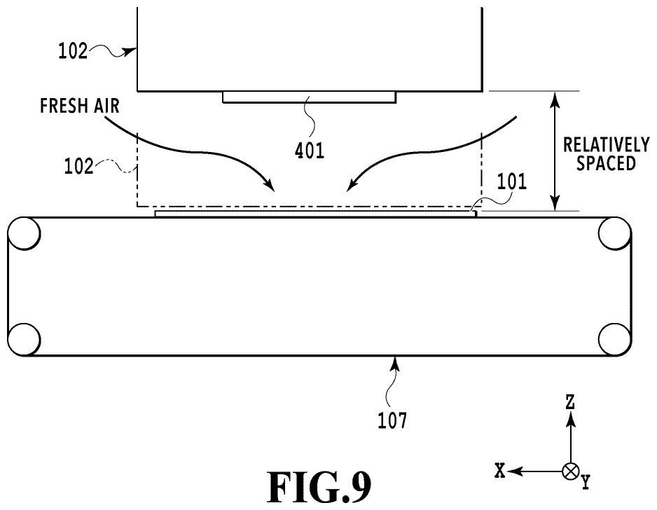

FIG. 9 is a schematic diagram showing a countermeasure to condensation that can be applied to the present embodiment.

As shown in FIG. 9, after printing is completed, the print head 102 and the printing medium 101 are relatively spaced apart from each other in the Z-direction. In the present embodiment, an arm (not shown) for lifting the print head 102 up from the printing position is provided as a moving mechanism 306 (see FIG. 3). Note that when printing is to be restarted, the arm lowers the print head 102 to the printing position from a lift-up position where the print head 102 has been lifted up. When the arm lifts the print head 102, air flows into the space between the print head 102 and the printing medium 101. This air has a relatively low humidity (dry air) as compared to the air under the print head 102.

As the print head 102 and the printing medium 101 are moved apart from each other, dry air as described above flows into the space between them, whereby relatively highly humid air that has been trapped between the print head 102 and the printing medium 101 is diffused. In other words, as compared to a case where the print head 102 is located at the printing position immediately after printing, the humidity in the space between the print head 102 and the printing medium 101 is reduced by lifting up the print head 102, which makes it possible to reduce the humidity in a state where a relatively high temperature is kept at the ejection orifice surface, for example, even after high-duty continuous printing has been performed.

Note that air may be sent into the space between the print head 102 and the printing medium 101 by driving a fan (not shown). In this case, it is preferable to send hot and dry air.

After the print head 102 and the printing medium 101 are spaced apart from each other by a first distance or more (for example, several centimeters), the sub-heaters 302 (see FIG. 7B, etc.) are turned off. In order to determine whether the print head 102 and the printing medium 101 are spaced apart from each other by the first distance or more, a position detecting sensor 307 (see FIG. 3) for detecting the position of the print head 102 is used. When the position detecting sensor 307 detects that the print head 102 is located at the lift-up position, it can be determined that the print head 102 and the printing medium 101 are spaced apart from each other by the first distance or more.

As described above, in the present embodiment, the sub-heaters 302 are turned off after the print head 102 and the printing medium 101 have been sufficiently spaced apart from each other. This makes it possible to restrain the temperature of the ejection orifice surface from dropping drastically as compared to the case where the sub-heaters 302 are turned off in a state where the print head 102 is located at the printing position. Therefore, according to the configuration of the present embodiment, it is possible to restrain the temperature of the ejection orifice surface from dropping below the dew point of the air under the ejection orifice surface. In other words, according to the configuration of the present embodiment, it is possible to restrain occurrence of condensation on the ejection orifice surface. Note that although the sub-heaters 302 are turned off in the present embodiment, it is not necessarily required to turn off the sub-heaters 302, and the power of the sub-heaters 302 may be reduced. When the sub-heaters 302 are not turned off, but kept in a power-reduced state, a waiting time required to resume printing can be shortened. Furthermore, since the sub-heaters 302 are not turned off, it is possible to surely restrain occurrence of condensation on the ejection orifice surface.

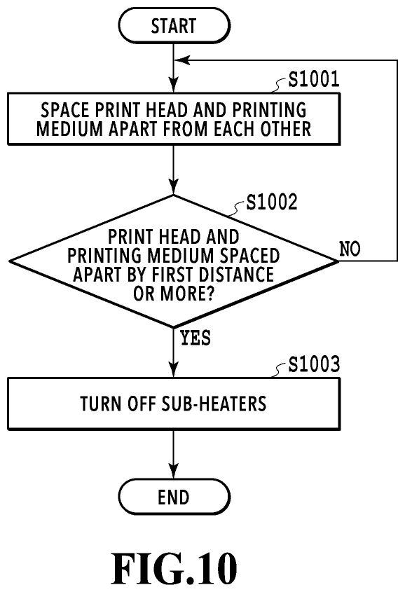

FIG. 10 is a flowchart showing an example of processing to be performed by the printing apparatus 100 of the present embodiment. In the following description, “S” appended at the beginning of each reference sign indicates a step (processing). The processing of each step shown in the flowchart in FIG. 10 is implemented by the CPU 3010 reading out a predetermined program from the ROM 3020 or the like to load the program in the RAM 303 and executing the program. This flowchart is triggered by the CPU 3010 acquiring information indicating that the ejection operation for printing has ended.

In S1001, the CPU 3010 drives the moving mechanism 306 to execute processing for relatively spacing the print head 102 and the printing medium 101 apart from each other.

In S1002, the CPU 3010 acquires position information regarding the positions of the print head 102 and the conveying unit 107 based on the output of the position detecting sensor 307, and determines whether the print head 102 and the printing medium 101 have been spaced apart from each other by the first distance or more. For example, the CPU 3010 acquires information indicating the trajectory of the movement of the print head 102 as an output of the position detecting sensor 307, and determines whether the print head 102 has moved from the printing position to the lift-up position.

When the print head 102 and the printing medium 101 have been spaced apart from each other by the first distance or more (that is, when they are sufficiently spaced apart from each other), the CPU 3010 executes the processing of S1003. On the other hand, when the print head 102 and the printing medium 101 are not sufficiently spaced apart from each other, the CPU 3010 repeats the processing of S1001.

In S1003, the CPU 3010 turns off the sub-heaters 302.

The foregoing relates to the content of the processing to be performed by the printing apparatus 100 of the present embodiment.

As described above, after printing is completed, the CPU 3010 of the present embodiment causes the print head 102 and the printing medium 101 to be spaced apart from each other. After the print head 102 and the printing medium 101 have been sufficiently spaced apart from each other, the sub-heaters 302 are turned off. However, as described above, instead of turning off the sub-heaters 302 in S1003, the power of the sub-heaters 302 may be reduced.

Therefore, according to the configuration of the present embodiment, the print head 102 and the printing medium 101 are sufficiently spaced apart from each other after printing is completed, whereby it is possible to disperse the atmosphere having high humidity present between the print head 102 and the printing medium 101. As a result, the humidity under the print head 102 decreases as compared to the case where the print head 102 is located at the printing position. In other words, according to the configuration of the present embodiment, it is possible to restrain the temperature of the ejection orifice surface of the print head 102 from dropping below the dew point in a high-humidity environment after printing is completed.

Therefore, according to the liquid ejection device of the present embodiment, occurrence of condensation can be restrained.

### Second Embodiment

In the first embodiment, the sub-heaters 302 are turned off or reduction of power thereof is started after the print head 102 and the printing medium 101 are sufficiently spaced apart from each other. However, the sub-heaters 302 may be turned off after the power thereof has been stepwise reduced in accordance with the distance by which the print head 102 and the printing medium 101 are spaced apart from each other. A second embodiment of the technique of the present disclosure will be described below with reference to the drawings. In the following description, components similar to or corresponding to those in the first embodiment are indicated by the same reference signs. The description of the components is omitted, and differences will be mainly described.

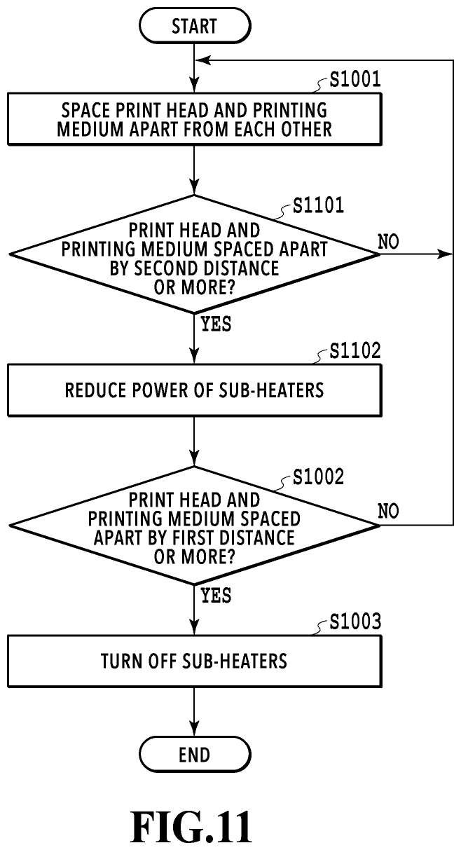

FIG. 11 is a flowchart showing an example of processing to be performed by the printing apparatus 100 of the present embodiment.

In S1001, the CPU 3010 drives the moving mechanism 306 to execute the processing for relatively spacing the print head 102 and the printing medium 101 apart from each other.

In S1101, the CPU 3010 acquires positional information regarding the positions of the print head 102 and the conveying unit 107, and determines whether the print head 102 and the printing medium 101 have been spaced apart from each other by a second distance smaller than the first distance or more. Here, the second distance is a distance at which it can be assumed that the humidity of the atmosphere present in the vicinity of the ejection orifice surface decreases due to the spacing from the printing position, so that the current temperature of the ejection orifice surface does not drop below the dew point of the atmosphere in the vicinity of the ejection orifice surface.

In S1102, the CPU 3010 reduces the power of the sub-heaters 302. However, the CPU 3010 does not turn off the sub-heaters 302.

In S1002, the CPU 3010 acquires positional information regarding the positions of the print head 102 and the conveying unit 107, and determines whether the print head 102 and the printing medium 101 are spaced apart from each other by the first distance or more.

In S1003, the CPU 3010 turns off the sub-heaters 302.

The foregoing relates to the content of the processing to be performed by the printing apparatus 100 of the present embodiment. Note that in S1003, instead of turning off the sub-heaters 302, the CPU 3010 may change the power to a still lower level than the current power. In this case, it is possible to obtain the same effect as the first embodiment.

### OTHER EMBODIMENTS

In the above embodiments, ink is used as the liquid, but the liquid that can be used in the technique of the present disclosure is not limited to ink. It is possible to use, as the liquid, various printing liquids other than ink, such as treatment liquids to be used to improve ink fixability on storage media, reduce gloss unevenness, and improve scratch resistance.

The above embodiments have been described on the assumption that cut sheet is used as the printing medium. However, storage media that can be applied to the present disclosure are not limited to cut sheet. For example, the technique of the present disclosure can also be applied even when a roll-to-roll type roll sheet in which sheet is continuously wound is used as the printing medium. Even with this configuration, the same effect as the above embodiments can be obtained.

In the above embodiment, the sub-heaters 302 are used as a configuration for adjusting the temperature of the ink. However, the ink temperature may also be adjusted using the printing elements 15. In this case, it is possible to increase the temperature of the ink without ejecting the ink by applying a voltage to the printing elements 15 to the extent that no bubble is generated from the ink while circulating the ink. In this case, the temperature of the ink may be adjusted using the sub-heaters 302 and the printing elements 15 in combination.

In the above embodiments, the print head 102 and the printing medium 101 are spaced apart from each other by lifting up the print head 102. However, the print head 102 may also be moved in a scanning direction (the Y-direction in FIG. 1) to space the print head 102 and the printing medium 101 apart from each other. Even with this configuration, the same effect as the above embodiments can be obtained. In other words, the technique of the present disclosure can also be applied to a so-called serial type printing apparatus 100 in which the print head 102 moves in the scanning direction.

The printing apparatus 100 may be also equipped with a moving mechanism for moving the printing medium 101 further downward from the underside of the print head 102. In this case, when the moving mechanism is driven, the printing medium 101 moves away from the print head 102 by the first distance or more. In this case, the moving mechanism may be, for example, a lowering mechanism for pulling the conveying unit 107 further downward from the underside of the print head 102. Note that when starting a printing operation, the lowering mechanism raises the conveying unit 107 to the printing position. In other words, an elevation device for raising and lowering the conveying unit 107 may also be provided.

In this case, after printing is completed, the conveying unit 107 is moved downward, and the sub-heaters 302 is turned off after the print head 102 and the conveying unit 107 are spaced apart from each other by the first distance or more. Even with this configuration, relatively highly humid atmosphere present between the print head 102 and the printing medium 101 can be diffused to reduce humidity. Therefore, even with this configuration, the same effect as the above-described embodiments can be achieved. It is also possible to provide both a moving mechanism for the print head 102 and a moving mechanism for the conveying unit 107.

The above-described embodiments have been described on the assumption that the print head 102 is spaced apart from the printing medium 101 which is conveyed by the conveying unit 107 and located under the print head 102. However, the technique of the present disclosure can be applied as long as the print head 102 and the conveying unit 107 (more specifically, a platen (not shown) for supporting the printing medium 101 included in the conveying unit 107) are relatively spaced apart from each other.

Furthermore, in the above embodiments, the sub-heaters 302 are turned off or the reduction of the power thereof is started relatively quickly after the print head 102 and the printing medium 101 are spaced apart from each other. However, by providing a predetermined waiting time after the print head 102 and the printing medium 101 are spaced apart from each other, the sub-heaters 302 may be turned off or the power thereof may be reduced after the waiting time has elapsed. With this configuration, the temperature of the ejection orifice surface can be kept higher than that in the above embodiments after the print head 102 and the printing medium 101 are spaced apart from each other.

In the above embodiments, ink is circulated. When ink is circulated, depending on the configurations of flow paths and heaters, a temperature dropping manner of the ejection orifice surface after the sub-heaters 302 are turned off may vary depending on the location. For example, the temperature tends to drop more easily near the corners of the ejection orifice surface. On the other hand, the temperature tends to drop less easily near the center of the ejection orifice surface. In this case, the temperature near the corners of the ejection orifice surface is more likely to drop below the dew point than the temperature near the center of the ejection orifice surface. For this reason, condensation is more likely to occur near the corners of the ejection orifice surface than near the center of the ejection orifice surface.

Therefore, after the sub-heaters 302 (first sub-heaters) provided near the center of the ejection orifice surface are turned off, the sub-heaters 302 (second sub-heaters) located near the corners of the ejection orifice surface may be turned off. According to this configuration, it is possible to restrain occurrence of condensation even when there is a temperature distribution on the ejection orifice surface. In this case, instead of turning off each sub-heater, the power of each sub-heater may be reduced.

The configuration for detecting the position of the print head 102 is not limited to the position detecting sensor 307 (see FIG. 3). For example, a sensor for continuously detecting the position of the print head 102 may be provided, or a sensor for detecting whether the print head 102 is located at the printing position may be provided. In addition to these sensors, a sensor for detecting whether the print head 102 and the conveying unit 107 have been spaced apart from each other by the first distance or more may also be provided.

Furthermore, the position of the print head 102 may also be detected using a time which has elapsed since the movement of the print head 102 starts and the number of pulses of a motor for moving the print head 102. In other words, the position of the print head 102 can be detected using any appropriate method.

The timing at which the sub-heaters 302 are turned off or the power of the sub-heaters 302 is reduced may also be determined while monitoring a condensation status or detecting the dew point in the vicinity of the ejection orifice surface.

In the above embodiments, the ejection heaters are provided as the printing elements 15. However, as long as it is possible to control the ejection of droplets using electrical signals, piezoelectric elements for ejecting liquid using mechanical deformation may also be used as the printing elements 15. Note that the technique of the present disclosure can also be applied to a liquid ejection device that ejects liquid using methods other than the above methods.

Furthermore, the parameters described in the above embodiments are merely examples. In other words, the above-mentioned parameters and the like can be appropriately modified in design depending on the system being used.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the printing apparatus of the present disclosure, it is possible to restrain occurrence of condensation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034512, filed Mar. 5, 2025, which is hereby incorporated by reference herein in its entirety.

What is claimed is:

1. A printing apparatus comprising:
a conveying unit configured to convey a printing medium in a conveying direction;
a print head configured to perform printing by ejecting liquid onto the printing medium;
a printing element substrate provided on the print head and having an ejection orifice surface on which ejection orifice for ejecting liquid is formed;
a temperature adjusting unit configured to adjust temperature of the printing element substrate;
a changing unit configured to change a relative position of the print head and the conveying unit; and
a control unit configured to control driving of the conveying unit, the print head, the printing element substrate, the temperature adjusting unit, and the changing unit, wherein
the control unit drives the temperature adjusting unit to adjust the temperature of the printing element substrate while the print head is performing printing, drives the changing unit to relatively space the print head and the printing medium apart from each other after printing is completed, and then reduces power of the temperature adjusting unit.

2. The printing apparatus according to claim 1, wherein the control unit adjusts the power of the temperature adjusting unit to prevent the temperature of the ejection orifice surface from dropping below a dew point of atmosphere present near the ejection orifice surface.

3. The printing apparatus according to claim 1, wherein the changing unit moves the print head relative to the conveying unit.

4. The printing apparatus according to claim 3, wherein the control unit causes the conveying unit to convey the printing medium while causing the print head to eject liquid, thereby performing printing.

5. The printing apparatus according to claim 4, wherein after printing is completed, the control unit drives the changing unit to raise the print head relative to the conveying unit to space the ejection orifice surface and a printing surface of the printing medium conveyed by the conveying unit apart from each other in a vertical direction.

6. The printing apparatus according to claim 1, wherein the changing unit moves the print head relative to the printing medium.

7. The printing apparatus according to claim 1, wherein the changing unit changes a distance between the ejection orifice surface and a printing surface of the printing medium conveyed by the conveying unit in a direction parallel to the conveying direction.

8. The printing apparatus according to claim 1, wherein after printing is completed and then a predetermined waiting time has elapsed, the control unit drives the changing unit to space the print head and the printing medium apart from each other and reduces the power of the temperature adjusting unit.

9. The printing apparatus according to claim 1, wherein after printing is completed, the control unit starts reduction of the power of the temperature adjusting unit during a process in which the changing unit is driven to space the print head and the printing medium apart from each other.

10. The printing apparatus according to claim 1, wherein the temperature adjusting unit is provided for each of a plurality of areas of the printing element substrate, and after printing is completed, the control unit reduces the power of the temperature adjusting unit corresponding to an area whose temperature is less likely to decrease among the plurality of areas, and then reduces the power of the temperature adjusting unit corresponding to an area whose temperature is likely to decrease.

11. A control method for a printing apparatus including a conveying unit configured to convey a printing medium in a conveying direction, a print head configured to perform printing by ejecting liquid onto the printing medium, a printing element substrate provided on the print head and having an ejection orifice surface on which ejection orifice for ejecting liquid is formed, a temperature adjusting unit configured to adjust temperature of the printing element substrate, and a changing unit configured to change a relative position of the print head and the conveying unit, the control method comprising:
driving the temperature adjusting unit to adjust the temperature of the printing element substrate while the print head is performing printing; and
driving the changing unit to relatively space the print head and the printing medium apart from each other after printing is completed; and then
reducing power of the temperature adjusting unit.

12. The control method according to claim 11, wherein the power of the temperature adjusting unit is adjusted to prevent temperature of the ejection orifice surface from dropping below a dew point of atmosphere present near the ejection orifice surface.

13. The control method according to claim 11, wherein the changing unit moves the print head relative to the conveying unit.

14. The control method according to claim 13, wherein printing is performed by ejecting liquid using the print head which has been positioned and conveying the printing medium using the conveying unit.

15. The control method according to claim 14, wherein, after printing is completed, the changing unit raises the print head relative to the conveying unit to space the ejection orifice surface and a printing surface of the printing medium conveyed by the conveying unit apart from each other in a vertical direction.

16. The control method according to claim 11, wherein the changing unit moves the print head relative to the printing medium.

17. The control method according to claim 11, wherein the changing unit changes a distance between the ejection orifice surface and a printing surface of the printing medium conveyed by the conveying unit in a direction parallel to the conveying direction.

18. The control method according to claim 11, wherein after printing is completed and then a predetermined waiting time has elapsed, the changing unit is driven to space the print head and the printing medium apart from each other, and reduction of the power of the temperature adjusting unit is started.

19. The control method according to claim 11, wherein after printing is completed, reduction of the power of the temperature adjusting unit is started during a process in which the print head and the printing medium are spaced apart from each other by the changing unit.

20. The control method according to claim 11, wherein the temperature adjusting unit is provided for each of a plurality of areas of the printing element substrate, and after printing is completed, reduction of the power of the temperature adjusting unit corresponding to an area whose temperature is less likely to decrease among the plurality of areas is started, and then reduction of the power of the temperature adjusting unit corresponding to an area whose temperature is likely to decrease is started.

21. A non-transitory computer-readable storage medium storing a program that causes a computer to execute a printing method for a printing apparatus having a conveying unit configured to convey a printing medium in a conveying direction, a print head configured to perform printing by ejecting liquid onto the printing medium, a printing element substrate provided on the print head and having an ejection orifice surface on which ejection orifice for ejecting liquid is formed, a temperature adjusting unit configured to adjust temperature of the printing element substrate, and a changing unit configured to change a relative position of the print head and the conveying unit, the printing method comprising:
controlling to drive the temperature adjusting unit to adjust the temperature of the printing element substrate while the print head performs printing; and
controlling to drive the changing unit to relatively space the print head and the printing medium apart from each other after printing is completed, and then reduce power of the temperature adjusting unit.
